(19) United States
(12) Patent Application Publication
(10) Pub. No.: US 2010/0169933 A1
(43) Pub. Date: Jul. 1, 2010

(54) ACCESSING AN EVENT-BASED MEDIA BUNDLE

(75) Inventors: Wei Wang, Barrington, IL (US); Dongge Li, Hoffman Estates, IL (US); Renxiang Li, Lake Zurich, IL (US); Cuneyt M. Taskiran, Schaumburg, IL (US); Yong Wang, Hoffman Estates, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/347,360

(22) Filed: Dec. 31, 2008

(51) Int. Cl. G06F 13/00

(52) U.S. Cl. 725/61

(57) ABSTRACT

Disclosed is a “bundle” of event-related multi-media content items provided to a customer of the event. The customer navigates through the bundle, tracks down selections of interest to himself, and “consumes” them. In some embodiments, the multi-media content items include recorded video clips, interviews, and other background information. Other content items can be live video feeds of the event taken from various viewpoints. Advertising for merchandise related to the event can be included. Some of the multi-media content items are designed to enhance the customer's experience of the event or to build loyalty. The media bundle is updated during the course of the event, removing items no longer of interest and adding new ones to keep the customer engaged. When the event is over, the media bundle can continue to operate to provide event recaps, post-event interviews, schedules for future events, and opportunities to purchase tickets for those future events.

### FIELD OF THE INVENTION

The present invention is related generally to multi-media publishing and, more particularly, to publishing and consuming bundles of related content items.

### BACKGROUND OF THE INVENTION

In a typical scenario, a customer purchases a ticket to attend an event, for example, a basketball game. While at the basketball arena, the customer walks by numerous licensed vendors selling items related to the particular event (e.g., a souvenir program), related to the teams playing in the event (replica jerseys), related to basketball (a basketball), or related to sports in general. Because the customer has self-selected himself as someone interested in this event (by purchasing the ticket and by attending), the vendors have a greater chance of selling their merchandise to this customer than to random passers-by on the street outside the arena. The customer is often delighted to have the opportunity to show loyalty to “his” team by purchasing from these vendors. These sales are also very important to the sponsor of the event, and in some instances the portion of the vendors' sales that go to the sponsor outweighs the profits made from ticket sales.

The sponsor of the event can derive further advantage from the customer's self-selection (in addition to the ticket price and whatever portion is received from the sales made by the licensed vendors). For example, the sponsor may be able to create a mailing list of self-selected customers based on information gather during the ticket-purchase process. The sponsor can use the mailing list to send advertising targeted at the self-selected customers.

In addition to traditional physical merchandise, the sponsor (or licensed vendors) may also choose to provide multi-media content. For example, a film of championship highlights can be sold at the venue or on-line. However, sales of multi-media content have to date followed the paths set by merchandising of physical objects and have not leveraged the unique opportunities provided by multi-media.

### BRIEF SUMMARY

The above considerations, and others, are addressed by the present invention, which can be understood by referring to the specification, drawings, and claims. According to aspects of the present invention, a “bundle” of event-related multi-media content items is provided to a customer of the event. The customer navigates through the bundle, tracks down selections of interest to himself, and “consumes” them.

In some embodiments, the multi-media content items include recorded video clips, interviews, and other background information. Other content items can be live video feeds of the event taken from various viewpoints. Advertising for merchandise related to the event, along with coupons for some of the items, can be included.

Some of the multi-media content items are designed to enhance the customer's experience of the event or to build loyalty. A live poll can be sent to registered customers asking questions about the progress of the event, and the results of the poll can be quickly distributed as another content item.

The media bundle is constantly updated during the course of the event, removing items no longer of interest and adding new ones to keep the customer engaged. When the event is over, the media bundle can continue to operate to provide event recaps, post-event interviews, schedules for future events, and opportunities to purchase tickets for those future events.

Bundling the multi-media content items into an interactive, inter-related, constantly updated whole improves the sponsor's ability to sell merchandise related to the event, but it also greatly enhances the customer's experience of the event and, possibly, his receptivity to the sponsor's future productions.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which the present invention may be practiced;

FIGS. 2a and 2b are simplified schematics of a device for accessing a media bundle;

FIG. 3 is a flowchart of an exemplary method for accessing a media bundle; and

FIG. 4 is a flowchart of an exemplary method for producing a media bundle.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

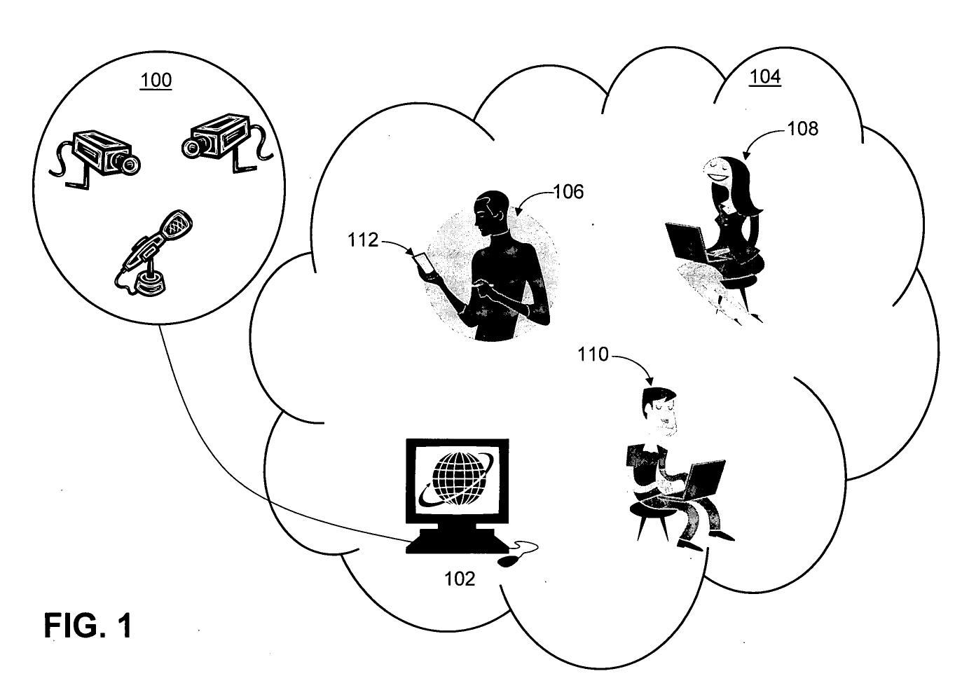

In FIG. 1, an event is offered in a venue 100. For purposes of the present discussion, assume that the event is a basketball game in a sporting arena 100, but the present invention is not limited to any particular type of event or type of arena. The “event” need not even be live, but could be, for example, a special showing by a museum, either a current exhibition or one already closed. Using one or more media servers 102, the event sponsor publishes various multi-media offerings in association with the event. The offerings can include live video feeds of the basketball game, taped highlights of past games, offers and coupons for merchandise purchased on-line or at the arena 100, interactive fan polls and games, and the like. While the sponsor can publish each offering separately, he can also assemble the offerings into a media “bundle.” The media bundle provides structure to the set of offerings with navigation links among them.

The media server 102 makes the event sponsor's multi-media offerings available over a communications network 104 to potential consumers 106, 108, and 110. In particular, the media server 102 can transmit the navigable media bundle, or a link to it, to each potential consumer 106, 108, 110. By means of a computing device 112, a potential consumer 106 can access the media bundle, navigate through it, and “consume” (that is, purchase merchandise or tickets, view videos, participate in on-line activities, etc.) those offerings of most interest to himself. Because the event sponsor's offerings are bundled, the potential consumer 106 is more likely to find items of interest to himself and become an actual consumer. The media bundle can also include special items not available to the general public but only available through the media bundle itself. This can increase the enjoyment of the more dedicated fans of the sponsor's events.

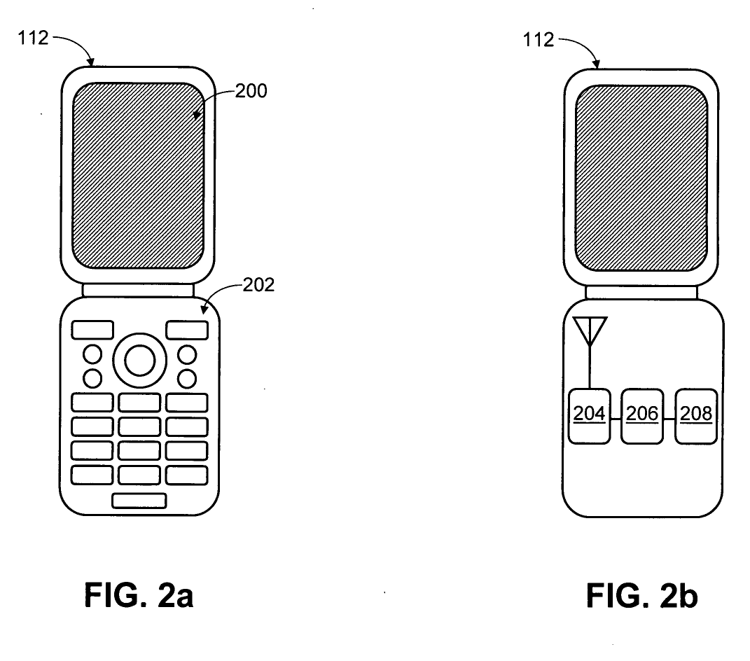

FIGS. 2a and 2b show a computing device 112 (e.g., a cellular telephone, personal digital assistant, personal computer, or television set-top box) that incorporates an embodiment of the present invention. FIGS. 2a and 2b show the device 112 as a cellular telephone in an open configuration, presenting its main display screen 200 to the potential consumer 106. Typically, the main display 200 is used for most high-fidelity interactions with the potential consumer 106. For example, the main display 200 is used to show video or still images, is part of a user interface for changing configuration settings, and is used for viewing call logs and contact lists. To support these interactions, the main display 200 is of high resolution and is as large as can be comfortably accommodated in the device 112. A device 112 may have a second and possibly a third display screen for presenting status messages. These screens are generally smaller than the main display screen 200. They can be safely ignored for the remainder of the present discussion.

The typical user interface of the computing device 112 includes, in addition to the main display 200, a keypad 202 or other user-input devices. A separate television screen and remote control usually form part of the user interface when the device 112 is a set-top box.

FIG. 2b illustrates some of the more important internal components of the computing device 112. The device 112 includes a communications transceiver 204, a processor 206, and a memory 208.

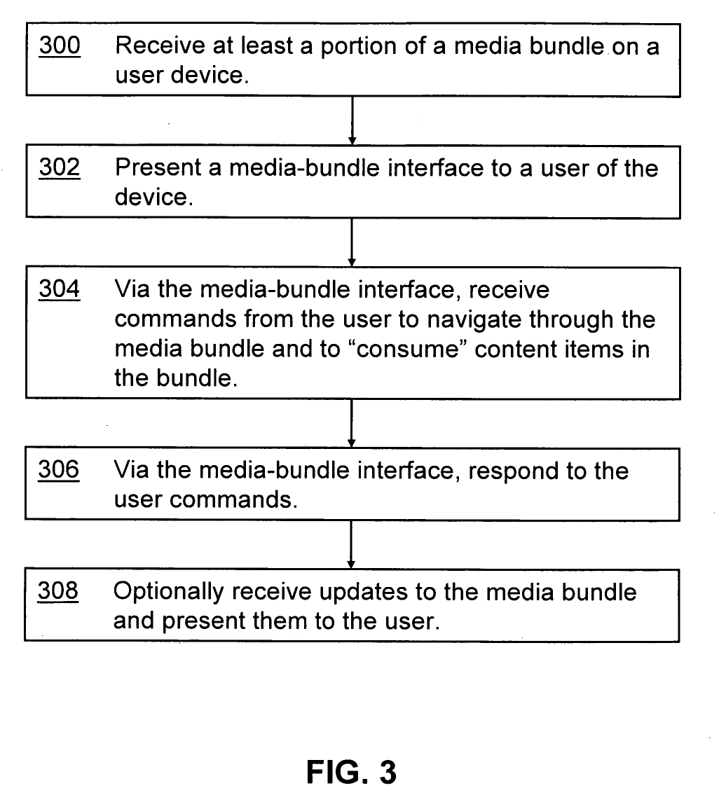

FIG. 3 presents an exemplary embodiment of a method usable by the consumer 106 of the media bundle. In step 300, the computing device 112 of the consumer 106 receives at least a portion of the media bundle from the computing server 102. Because the media bundle is potentially very large (including videos of past championship highlights, for example), often the device 112 only receives links to multi-media offerings at this stage. Some devices 112 have an enormous amount of available memory (e.g., a set-top box in conjunction with a disk drive for storing video), and for these devices entire multi-media offering may be streamed and stored even before the user 106 selects them. The trade-offs between rapid access time (which call for downloading as much as possible as soon as possible) and limited communications bandwidth and memory available to the computing device 112 (which call for limiting the downloads to links until specific offerings are selected by the consumer 106) are well known in the art and should be considered in each deployment of a media bundle.

Step 300 does not assume that every potential consumer 106, 108, 110 receives the exact same media bundle (or portion thereof) even when they are all accessing the same event. In addition to considerations of the various capabilities of bandwidth and memory for the various computing devices 112 used by the various potential consumers 106, 108, 110 discussed above, the event sponsor can set up different levels of content and sophistication of the media bundles for consumers who have displayed different levels of interest. That is, one consumer 106 can pay more for a more complete media bundle, or may be sent a more complete media bundle based on his past history of purchases of tickets or merchandise for a basketball team participating in the game.

The computing device 112 may also receive a unique interface for the media bundle in step 300. Some media bundles may simply rely upon a common, well known interface such as an Internet browser, but the media bundle publisher may also choose a unique interface with special features (supported, for example, by Java applets) and download this interface in step 300.

In step 302, the consumer 106 accesses the media bundle on his computing device 112. In step 304, the consumer 106 uses the navigation interface of his device 112 to review the offerings in the media bundle and to select those items that particularly interest him. The navigation and selection commands of the consumer 106 are carried out in step 306.

As one example, the event sponsor may have several cameras set up at the basketball arena. The consumer 106 can choose to watch the live feed from any of these cameras (or several at once in different windows on the display screen 200 of his device 112), or he can choose to watch replays from different angles. This example shows that the media bundle can be very entertaining even for a consumer 106 who is actually in the arena 100 watching the event live: The media bundle can enhance his experience by showing him views that he cannot see live from his seat in the arena 100.

In another scenario, the media bundle includes an interactive poll. For example, the fans can vote on the most valuable player of the game or on the quality of the half-time show. Combining access to archival video and statistics with the experience of the live game, fans can be asked to compare the performance of a rising star with one of the past greats of the game. If the event is a lecture rather than a game, then the lecturer can send out a pop quiz to see who is still paying attention or whether the audience can understand his presentation.

Security can be important to different sponsors for different reasons. Mentioned above is the possibility that different consumers access media bundles of different completeness for the same event. Consumers may be urged to register (and potentially pay) for access to a better media bundle. Then only registered consumers get the full media bundle, while a lesser media bundle may be available for free to everyone as a marketing ploy.

Step 308 is optional but potentially important. The media bundle need not remain static during the time when the consumer 106 is accessing it. Updates can be provided as more multi-media offerings become available or relevant to the developing event. Special merchandise or activities that are available “Only for the next five minutes!” can be sent to promote ongoing interest in the media bundle. In a school situation, a test can be added to the media bundle at a specific time and removed at a later time so that all students are given the same amount of time to complete it.

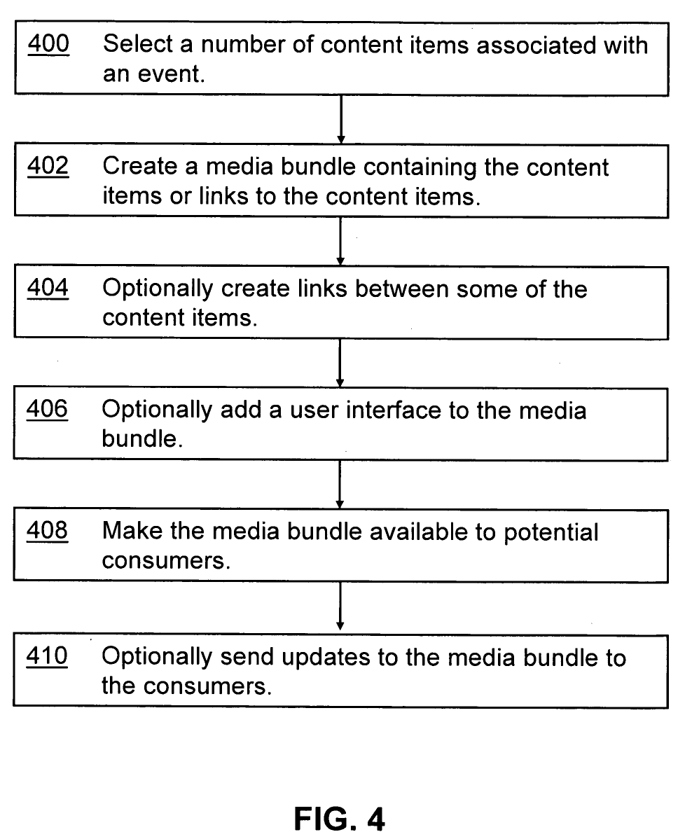

FIG. 4 presents a method that can be used by the event sponsor when creating and publishing a media bundle. Much of the method of FIG. 4 mirrors the experience of the consumer 106 of the media bundle as described in relation to FIG. 3, but there are some important points to make.

In steps 400, 402, 404, and 406 of FIG. 4, the event sponsor creates the media bundle by selecting appropriate multi-media offerings, adding structure to the set of offerings, and possibly adding a unique user interface for the media bundle. The structuring can be very important, especially when the number of offerings is very great. By careful linking, the event sponsor can promote certain items that may otherwise go unnoticed in a long list of similar items. Special merchandise tied to the players in tonight's game, for example, can be highlighted.

In step 408, the event sponsor makes the media bundle available at least to registered consumers and maybe to a general audience. Updates to the media bundle in step 410 can reflect ongoing situational changes. For example, a player just breaks a team or league record. Merchandise particular to that player, and to previous players who held that record, can be highlighted.

A carefully structured media bundle can guide the consumer 106 much better than a simple on-line catalog would. The addition of live feeds and interactive activities enhances the experience even of those consumers who view the event in person at the arena 100. Targeted toward the more dedicated fans, a media bundle can enhance the relationship between those fans and the teams participating in the event. In short, adding a media bundle to an event can increase the revenue to the event sponsor while it increases the enjoyment of the consumer 106.

In view of the many possible embodiments to which the principles of the present invention may be applied, it should be recognized that the embodiments described herein with respect to the drawing figures are meant to be illustrative only and should not be taken as limiting the scope of the invention. For example, different media-bundle user interfaces are appropriate to different types of events and to different levels of complexity of the media bundle. Other communication arrangements and the addition of other known media types are possible and may be called for in various environments. Therefore, the invention as described herein contemplates all such embodiments as may come within the scope of the following claims and equivalents thereof.

We claim:

1. A method for accessing an event-based media bundle, the event-based media bundle comprising a plurality of links to content items associated with an event and links between content items, the method comprising:
receiving at least a portion of the event-based media bundle;
presenting a media-bundle interface to a user;
receiving from the user interface commands to select links to navigate through the event-based media bundle and to consume content items linked to the event-based media bundle; and
responding to the received commands.

2. The method of claim 1 wherein the media bundle is based on an event selected from the group consisting of: a visit to a venue, a sporting event, a musical performance, a theatrical performance, a class, and a museum exhibit.

3. The method of claim 1 wherein content items are selected from the group consisting of: a live video feed, a live audio feed, recorded video, recorded audio, an image, text-based information, a coupon, a user poll, advertising, and metadata.

4. The method of claim 1 wherein the event-based media bundle comprises a content item.

5. The method of claim 1 wherein the event-based media bundle comprises at least a portion of the media-bundle interface.

6. The method of claim 1 wherein receiving at least a portion of the event-based media bundle comprises receiving via broadcast or multicast over a communications network.

7. The method of claim 1 wherein responding to the received commands comprises receiving a selected content item over a communications network.

8. The method of claim 1 further comprising:
registering with a provider of the event-based media bundle.

9. The method of claim 1 further comprising:
receiving an update to the event-based media bundle during the event.

10. A device for accessing an event-based media bundle, the event-based media bundle comprising a plurality of links to content items associated with an event and links between content items, the device comprising:
a transceiver for receiving at least a portion of the event-based media bundle;
a memory operatively coupled to the transceiver and configured for storing at least a portion of the event-based media bundle; and
a processor operatively coupled to the transceiver and to the memory and configured for presenting a media-bundle interface to a user, for receiving from the user interface commands to select links to navigate through the event-based media bundle and to consume content items linked to the event-based media bundle, and for responding to the received commands.

11. The device of claim 10 wherein the device is selected from the group consisting of: a cellular telephone, a personal digital assistant, a computer, a set-top box.

12. The device of claim 10 wherein the transceiver is further configured for:
receiving a selected content item over a communications network.

13. The device of claim 10 wherein the transceiver is further configured for:
receiving an update to the event-based media bundle during the event.

14. A method for producing an event-based media bundle, the method comprising:
selecting a plurality of content items associated with an event;
adding to the event-based media bundle links to the selected content items;
adding to the event-based media bundle links between some of the selected content items; and
publishing the event-based media bundle.

15. The method of claim 14 further comprising:
transmitting at least a portion of the event-based media bundle via broadcast or multicast over a communications network.

16. The method of claim 14 further comprising:
producing and transmitting an update to the event-based media bundle during the event.
